(19) United States
(12) Patent Application Publication
(10) Pub. No.: US 2003/0012352 A1
(43) Pub. Date: Jan. 16, 2003

(54) Application of metering tones to a DSL and voice communications network

(76) Inventors: Serdar Kiykioglu, Plano, TX (US); Guozhu Long, Fremont, CA (US); Sanjay Gupta, Union City, CA (US)

Correspondence Address: FENWICK & WEST LLP, TWO PALO ALTO SQUARE, PALO ALTO, CA, 94306, US

(21) Appl. No.: 10/194,923

(22) Filed: Jul. 12, 2002

Related U.S. Application Data
(60) Provisional application No. 60/305,323, filed on Jul. 13, 2001.

(51) Int. Cl. H04M 15/00; H04M 17/00

(52) U.S. Cl. 379/114.01; 379/111; 379/140; 379/153

(57) ABSTRACT

A metering tone is applied to a transmission line by a DSL modem on behalf of a voice circuit, rather than being applied directly by the voice circuit. Various techniques for applying the metering tone to the data path are described. Because the metering tone is passed to the network in the data path rather than in the voice path, the tone is subject to the high-pass filtering associated with the data path rather than the low-pass filtering associated with the voice path. Accordingly, the metering tone is not attenuated by the splitter or by analogous features in a splitterless system.

### CROSS REFERENCE TO RELATED APPLICATIONS

This application claims the benefit under 35 U.S.C. § 119(e) of U.S. Provisional Application No. 60/305,323, filed Jul. 13, 2001, which is herein incorporated in its entirety by reference.

### BACKGROUND

1. Field of the Invention

The invention relates to the application of metering tones to a transmission line that carries voice and DSL data, and more particularly, to the application of metering tones to the DSL data path in such a network to avoid the attenuation of the tones.

2. Background of the Invention

To monitor usage of voice telephone services and facilitate billing for that usage, telephone voice circuits in some countries employ a feature called metering. The metering feature operates by generating a metering signal and superimposing this signal on the telephone transmission line. The metering signal comprises one or more metering tones, which are typically sinusoidal tones above the audible frequency range in a telephone system. The actual parameters of the tones depend on the country's metering standards, and one example is a pair of tones at 12 or 16 kHz and 2.3 or 5.1 Vp.

The metering signal is transmitted over the subscriber line to a customer and then received by customer premises equipment (CPE), such as a standard telephone. At the CPE, a device such as a metering box or subscriber billing center receives the metering signals and registers the usage. In the case of a pay phone, the metering signal causes the pay phone to drop deposited coins or debit a phone card. Monitoring and billing are thus accomplished at the customer end through receipt of the metering tones. But the increasing use of telephone lines for both voice and data transmission, as with digital subscriber line (DSL) technology, creates special problems for implementing the metering feature.

With DSL, traditional phone service is delivered to a customer over the same telephone line as digital data. The term DSL refers to different implementations of DSL technology, such as ADSL, HDSL, SHDSL, and RADSL. One type of telephone service is often referred to in the field of telephone communications as POTS, or “plain old telephone service.” The analog POTS signal occupies a telephone line's low frequency bandwidth, e.g., between 0 and 4 kHz. This leaves the telephone line's higher usable bandwidth free for the transmission of digital data.

At the telephone company's central office (CO), a transceiver, such as a digital loop carrier (DLC) or a voice-enabled DSL access multiplexer (DSLAM), combines the low-frequency POTS signal with the high-frequency digital data signals for transmission to a customer over a subscriber loop. A splitter is used at the CO and the CPE to separate a received signal into its low frequency voice component and its high frequency data component. A splitter also operates to combine the high and low frequency voice and data signals onto the line. The splitter's filtering function, however, may attenuate the metering signals, which are above the POTS frequency range. The resulting attenuation of the metering signals renders their detection at the CPE difficult or impossible. Similarly, splitterless DSL technologies have also been shown to attenuate metering signals.

Therefore, traditional POTS plus DSL overlay networks cannot be deployed on a system that uses metering signals for billing. It is therefore desirable to enable the application of metering tones to a local loop configured with a splitter or splitter-related technology (including splitterless technologies), which would otherwise attenuate the tones.

### SUMMARY OF THE INVENTION

Accordingly, the invention enables the application of metering tones to a transmission line (such as a subscriber loop) configured with a splitter or other splitterless technology. In an embodiment, a metering tone is generated and applied to a subscriber line by the DSL modem on behalf of the voice circuit, rather than being applied directly by the voice circuit. Because the metering tone is passed to the network in the data path rather than in the voice path, the tone is subject to the high-pass filtering associated with the data path rather than the low-pass filtering associated with the voice path. Accordingly, the metering tones are not attenuated by the splitter or by analogous features in a splitterless system.

In one embodiment, a voice circuit or other external module sends a metering tone instruction to the DSL modem rather than apply the metering tones to the line directly. The DSL modem in turn generates the appropriate metering tones and applies them to the data path. In one embodiment, a metering tone is generated digitally and then applied to the data signal on a transmit portion of the data path. The data signal and metering tone are then converted into an analog signal in an analog front end. The DSL modem can be configured, for example, to digitally amplify the generated metering tone above that of its required level to account for any further attenuation due to filtering in the data path.

In another embodiment, a metering tone is generated digitally and then converted into an analog signal in an analog front end separately from the data signal. The analog metering tone is then applied to the analog data signal on a transmit portion of the modem's data path.

In another embodiment, an analog metering tone generator generates an analog metering tone responsive to the metering tone instruction. This analog metering tone is then applied to the analog data signal on a transmit portion of the modem's data path.

In another embodiment, the DSL modem receives an analog metering tone from an external module, such as the voice circuit. The received metering tone is then added to a transmit portion of the modem's data path. The metering tone can be filtered to avoid causing noise in the higher DSL data frequency band when the tone is added to the data signal.

The invention thus allows the application of metering tones to a subscriber loop configured with a splitter or other splitterless DSL technology that would otherwise attenuate the metering tones.

### BRIEF DESCRIPTION OF THE DRAWINGS

FIG. 1 is a block diagram of a splitter-based system configured in accordance with an embodiment of the invention.

FIG. 2 is a block diagram of a portion of a DSL modem configured in accordance with an embodiment of the invention.

FIG. 3 is a block diagram of a portion of a DSL modem configured in accordance with another embodiment of the invention.

FIG. 4 is a block diagram of a portion of a DSL modem configured in accordance with another embodiment of the invention.

FIG. 5 is a block diagram of a portion of a DSL modem configured in accordance with another embodiment of the invention.

### DETAILED DESCRIPTION OF THE PREFERRED EMBODIMENTS

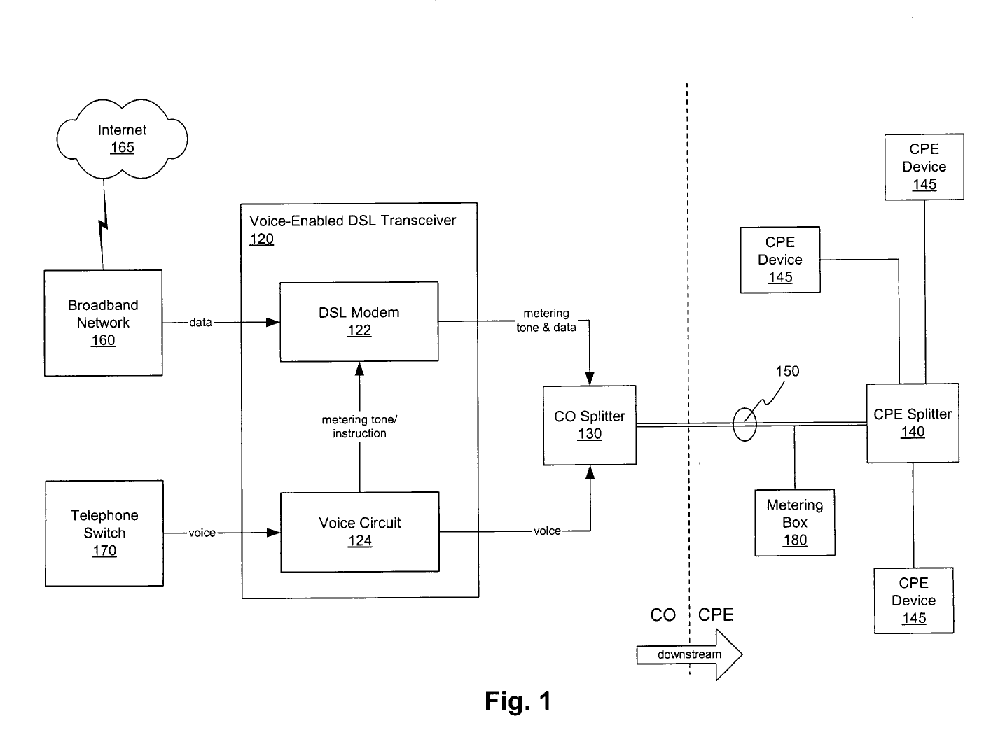

FIG. 1 is a block diagram of a splitter-based DSL communications system, showing information flow generally in a downstream direction, defined as from a central office (CO) to a customer premises equipment (CPE) 110. The CO side of the network includes a voice-enabled DSL transceiver 120, which comprises a DSL modem 122 and an analog voice circuit 124, and a CO splitter 130. The CPE side of the network includes a CPE splitter 140, one or more CPE devices 145, and a metering box 180, such as telephone devices and/or computer modems.

This system thus allows for both DSL and voice service (e.g., POTS) to be provided over the same line 150, often called a subscriber line or local loop. A typical subscriber line is a copper twisted pair having a usable spectral range of up to 2 MHz for a given distance of communication; however, other line types such as fiber optic cable or coaxial cable may be used. In one embodiment, the voice service is POTS, which operates in the low frequency portion of the spectral range (e.g., about 200 Hz to 4 kHz), and the DSL service operates in higher frequency ranges (e.g., above 25 kHz). Other frequency schemes are apparent in light of this disclosure.

In the downstream direction, higher frequency data is received from a broadband network 160, such as an ATM network, a broadband ISDN, an IP network, or a TDM network of a T-carrier system (e.g., T1/DS1 or T3/DS3). The broadband network 160 is typically coupled to the Internet 165 or another wide-area network for communicating electronic data therebetween. This data is received and processed by the DSL modem 122 in the transceiver 120 and provided to the line 150 via a high-pass filter in the CO splitter 130. Likewise, a lower frequency voice signal is received from a narrow-band telephone switching network 170, such as a GSTN, narrow-band ISDN, or PCM highway. This voice signal is received and processed by the voice circuit 124, which is for example a POTS line card or other voice service circuit. The processed voice signal is then provided to the line 150 via a low pass filter in the CO splitter 130.

In the receive direction, the splitters 130,140 separate the incoming signals so that the low and high frequency band signals can be routed to their corresponding destinations. For example, the CPE splitter 140 separates a received signal and filters out the higher frequencies of the signal to provide a voice signal to telephonic equipment, and further filters out the lower frequencies of the received signal to provide a data signal to the computer modem or other DSL data devices. In the transmit direction, the splitters 130,140 operate to couple the outgoing high, frequency data and low frequency voice onto the line in their respective frequency bands. The combined signal is then communicated to a remote location, e.g., from the CO to the CPE, or the reverse.

To implement the metering function, the metering tones are applied to the line 150 by way of the DSL modem 122. In one embodiment, the voice circuit 124 receives an instruction to apply a metering tone, or the actual metering tone itself, from the telephone switch 170. The voice circuit 124 then sends the metering tone or the instruction therefor to the DSL modem 122. Responsive to receiving the tone or instruction, the modem 122 applies a corresponding metering tone to the data signal carried on the data path. The CO splitter 130 receives the metering tone and data signal from the DSL modem 122 and the voice signal from the voice circuit 124 and sends the voice, data, and metering signals to the CPE over line 150. Because the voice path (e.g., through the voice circuit 124) is subject to low-pass filtering by the CO splitter 130 and the data path (e.g., through the DSL modem 122) is subject to high-pass filtering in the CO splitter 130, applying the metering tone to the data path rather than to the voice path advantageously avoids attenuation of the metering tone in the CO splitter 130.

At the CPE, a metering box 180 receives the metering tone and registers the usage. Alternative embodiments employ other mechanisms for performing the function of the metering box 180, such as a subscriber billing center. Monitoring a customer's telephone usage and billing the customer for the usage are thus accomplished at the customer end through receipt of the metering tone.

Although a particular configuration is shown in FIG. 1, various configurations for the CPE splitter 140, CPE devices 145, and metering box 180 can be used with this invention. For example, the CPE side may be configured as a distributed splitter system, where each CPE device 145 may have its own low-pass filter, and the metering box 180 may be located upstream or downstream of any splitter or other filtering mechanism. Moreover, depending on the metering tones required, it might be necessary to adjust the high-pass filter portion of either or both splitters 130,140 to avoid attenuation of the metering tones therein. Such an adjustment can be performed by way of adjusting the cutoff frequency of the filter or reducing the rate at which the filter drops off (e.g., reducing the number of poles of the filter).

The splitters, as well as other devices described herein, can be implemented in conventional technology. The architecture and functionality of the DSL modem and voice circuit will be discussed in more detail below. Additional components, such as repeaters and interfaces, may also be included in the system. Moreover, it will be apparent that the principles of the present invention can be also used with other technologies that perform the splitter functionality, such as those described in U.S. patent application Ser. Nos. 09/570,804, “Central Office Interface Techniques,” and 10/138,197, “Splitterless, Transformerless, Voice Service Independent ADSL Interface,” both of which are herein incorporated by reference.

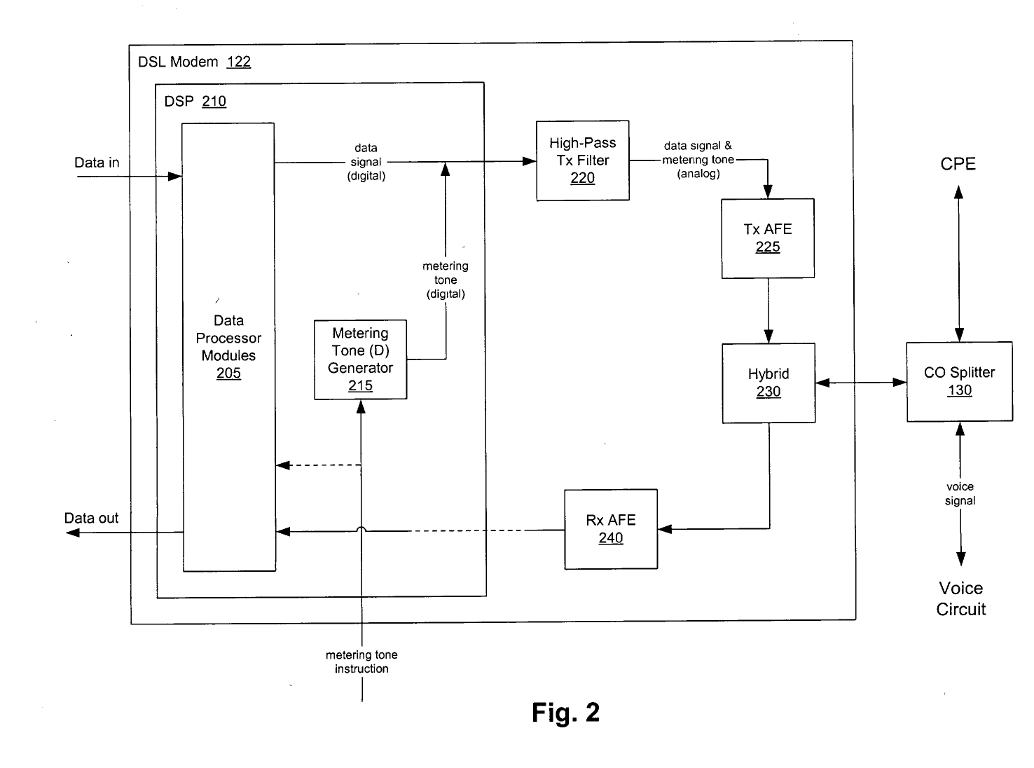

In one embodiment, the voice circuit 124 or other external module sends a metering tone instruction to the DSL modem 122, which in turn generates the appropriate metering tone or tones and applies them to the data path within the modem 122. FIG. 2 illustrates one embodiment in which a metering tone is generated digitally and then applied to the data signal on a transmit portion of the data path.

The data path in the DSL modem includes a transmit portion and a receive portion. The transmit portion of the data path in the DSL modem 122 includes a digital signal processor (DSP) 210, a transmit (Tx) high-pass filter 220, and a Tx analog front end (AFE) 225. The receive portion includes a receiver (Rx) AFE 240, and the digital signal processor (DSP) 210. Both the receiver and transmit portions of the data path may include additional well-known components and modules that are not shown, such as modules for communicating the received data signal to a coupled broadband network 160.

The transmit portion and a receive portion of the data path are coupled together by a hybrid 230. In one embodiment, the hybrid 230 performs a 2-to-4-wire conversion, one pair for receiving on the receiver portion of the data path and the other pair for transmitting on the transmit portion. The hybrid 230 thus converts the bi-directional two-wire signal from the splitter 130 into two pairs of one-directional transmissions that represent the receive and transmit portions of the data path. Accordingly, the hybrid 230 implements an interface between each of the one-way transmit and receive portions of the data path to a two-way communication with the CPE over line 150. The hybrid 230 may also include a DSL coupling transformer, although transformerless configurations are also possible.

In the receive portion, the DSL modem 122 receives digital data (e.g., from a broadband network 160) and processes it for transmission over the subscriber line 150. This processing takes place in one or more data processing modules 205, which perform well-known functions such as framing, mapping, filtering, and encoding the input data signal. These modules are often located in a digital signal processor (DSP) 210, which may be implemented in one or more integrated circuit chips or by any of a wide variety of data processing methods.

Responsive to the metering tone instruction, a digital metering tone generator 215 generates a digital metering tone having a suitable magnitude and frequency. The parameters of a suitable metering tone are dictated by the standards for the area, and in one example are a pair of tones at 12 or 16 kHz and 2.3 or 5.1 Vp. The metering tone instruction or another signal indicating that a metering tone instruction has been sent is preferably sent to the data processing modules 205, thereby allowing the DSP 210 to make any necessary adjustments in the data signal to accommodate the tones. Preferably, the metering tone is generated to be free of frequency components in the voice and data signal frequency ranges to avoid creating noise in the corresponding bands. The digital metering tone generator 215 may be implemented within the DSP 210 as shown, or it may be a separate module in the system. The output of the generator 215 is coupled to the data path, thereby applying the generated metering tone to the data signal thereon.

The data signal and metering tone are then passed through a transmitter (Tx) high-pass filter 220, which shapes and filters the data signal to produce a continuous time signal and reduce out-of-band signal components. This helps to reduce noise in the voice band when the data and voice signals are combined in the CO splitter 130. The filtered data signal and metering tone are then converted into a corresponding analog signal in a transmitter (Tx) analog front end (AFE) 225. The Tx AFE 225 includes a digital to analog converter for performing this conversion, and further includes a line driver for driving the signal onto the line via the hybrid 230. The Tx AFE 225 may also include an interpolator to perform interpolation prior to the digital to analog conversion.

Because the metering tone typically has a frequency between the voice and DSL frequency bands, the metering tone's frequency is near the cutoff frequency of the Tx high-pass filter 220. Accordingly, the metering tone may be somewhat attenuated by the Tx high-pass filter 220. In such a case, the digital metering tone generator 215 preferably digitally amplifies the generated metering tone above that of its required level to account for this and any other attenuation due to high-pass filtering in the data path. The amount of amplification needed depends on the tone and the filtering characteristics of the data path, but a typical application would require the addition of about a 20 db above the required metering tone magnitude. The components of the DSL modem 122, such as the Tx AFE 225, may be configured with a higher dynamic range that can accommodate the amplified metering tone.

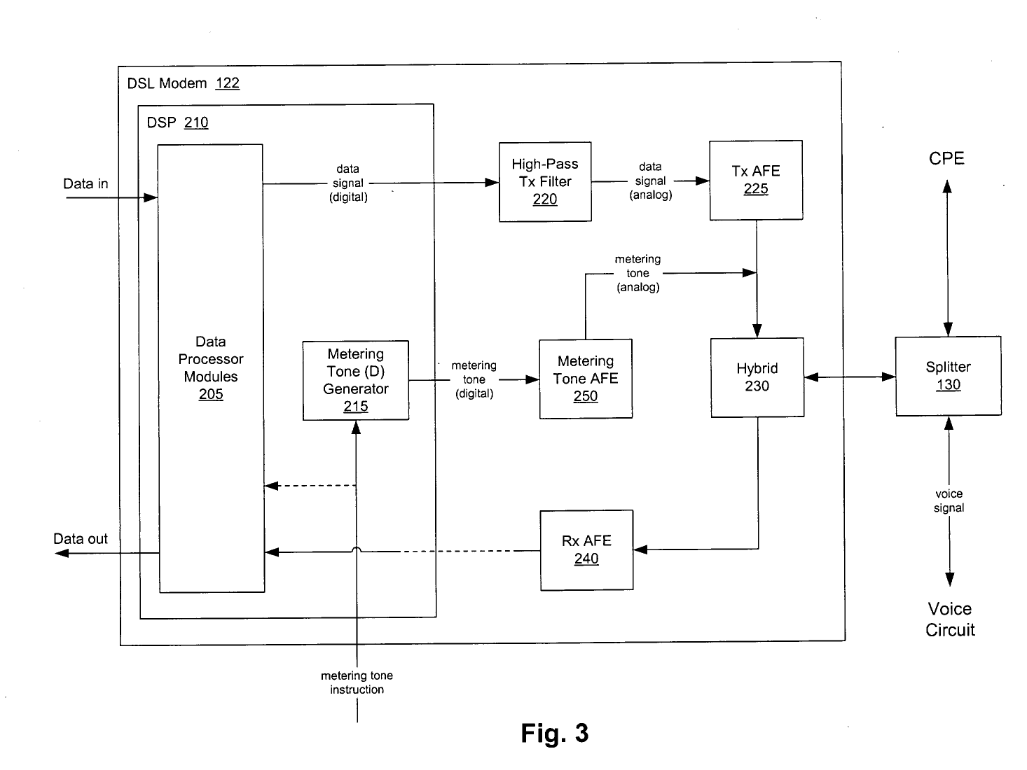

FIG. 3 illustrates an alternative embodiment for generating and applying a metering tone to the data path in the DSL modem 122. In this embodiment, the digital metering tone generator 215 generates a metering tone in response to an instruction, e.g., from a voice circuit 124. Unlike the previous embodiment, the generated metering tone is converted into an analog signal in a separate metering tone AFE 250. The analog metering tone is then applied to the analog data signal on a transmit portion of the modem's data path. In this way, the analog metering tone bypasses the Tx high-pass filter 220 and the Tx AFE 225. Advantageously, this avoids the attenuation of the metering tone in the Tx filter 220, thus reducing or eliminating the need to amplify the metering tone and expand the dynamic range of the transmit path components.

In an alternative to an aspect of the embodiment shown in FIG. 3, the generated digital metering tone and the digital data signal are converted into corresponding analog signals by separate digital-to-analog (D/A) converters, rather than completely separate AFEs. Once converted into analog signals, the metering tone and the data signal may be combined. This allows the metering tone and data signal to be driven by the same line driver and perhaps share other components of a typical AFE, (other than the D/A converter). Because line drivers generally consume a relatively large amount of power, this configuration advantageously avoids the need for two separate line drivers, and other components of the AFE, thereby reducing cost and power consumption of the system.

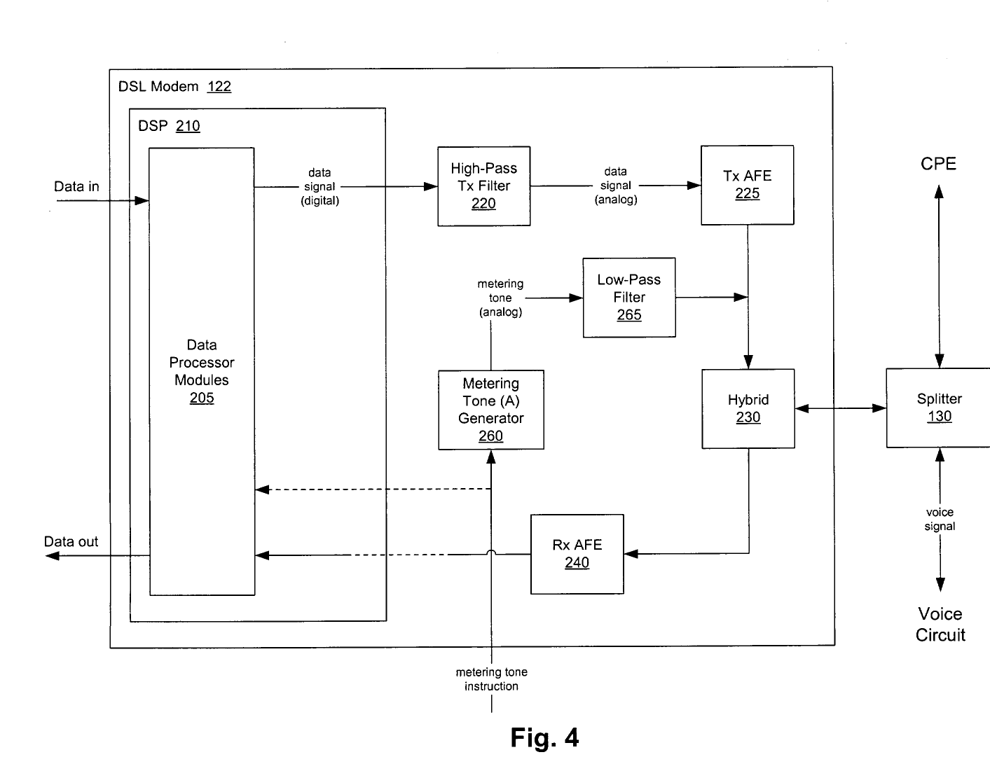

In another embodiment, an analog metering tone is generated responsive to the metering tone instruction. As shown in FIG. 4, the DSL modem 12 includes an analog metering tone generator 260 coupled to receive a metering tone instruction. Responsive to receiving the instruction, the analog generator 260 generates an appropriate metering tone for application to the analog data signal on a transmit portion of the modem's data path. The analog metering tone may be passed through a low-pass filter 265 before being applied to the analog data signal. Alternatively, the metering tone may be passed through a band-pass filter. Such filtering of the generated metering tone helps to confine the metering tone burst spectrum, which may include high frequency components that can cause noise in the data signal if not removed. This embodiment also benefits from avoiding the attenuation of the metering tone in the Tx filter 225.

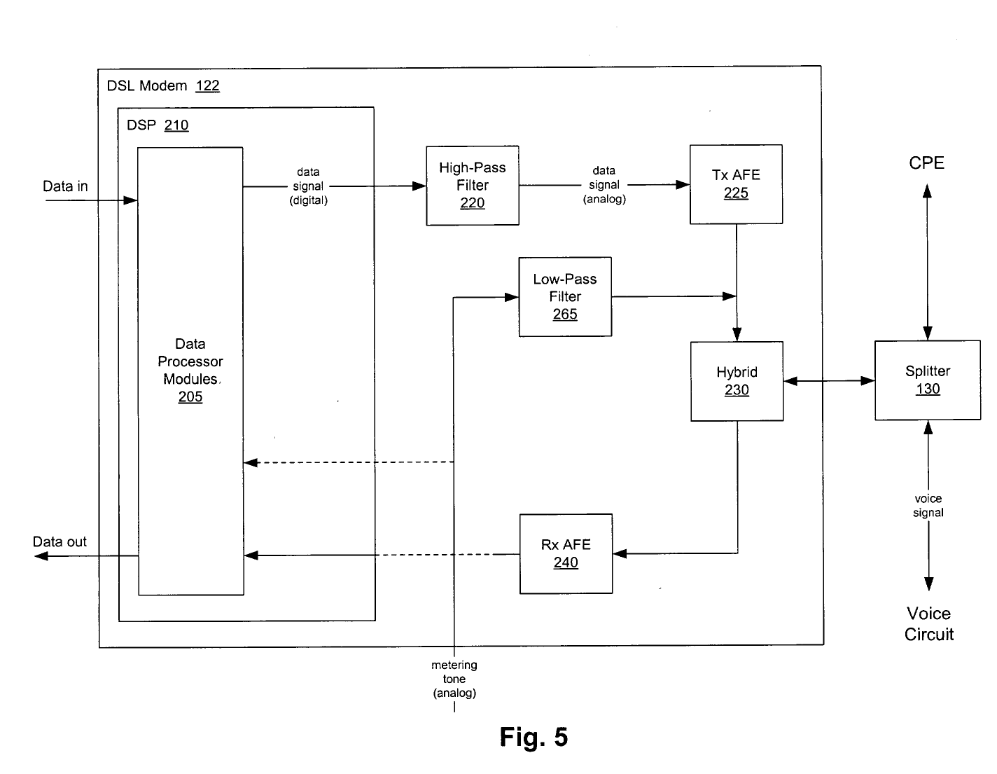

In yet another embodiment, shown in FIG. 5, the DSL modem 122 receives an analog metering tone from an external module, such as the voice circuit. The received metering tone is then added to a transmit portion of the modem's data path. The metering tone may be filtered with a low-pass (or band-pass) filter 265 to attenuate burst noise in the higher DSL data frequency band.

Although specific embodiments have been described, variations on these embodiments are possible without departing from the present invention. For example, the components of a transceiver can be implemented in hardware, software, firmware, or any combination thereof. For instance, the data processor, metering tone generators, and filter modules can all be implemented as a set of instructions executing on a digital signal processor or other suitable processing environment. Alternatively, these modules can be implemented in purpose-built silicon as a chip or chip set. Likewise, the components or a sub-set of the components can be implemented as an apparatus or device (e.g., transceiver-on-a-chip or modem line card). Alternatively, these modules can be can be incorporated into an apparatus such as a computer program product embodied on a computer readable medium, such as a server or disk. It is also noted that many other well-known components are typically included in the transceiver architecture but not described.

Accordingly, the foregoing description of the embodiments of the invention has been presented for the purposes of illustration and description. It is not intended to be exhaustive or to limit the invention to the precise forms disclosed. Persons skilled in the relevant art will appreciate that many modifications and variations are possible in light of the above teaching. For example, it will be apparent from this disclosure that the present invention is not intended to be limited to POTS, but can be applied to other voice services such as Special Services or Foreign Exchange Subscriber. Numerous such voice processing applications and corresponding voice circuitry can be combined with DSL technologies to accommodate metering tones in accordance with the principles of the present invention. It is therefore intended that the scope of the invention be limited not by this detailed description, but rather by the claims appended hereto.

We claim:

1. A system for applying a metering tone to a DSL transmission, the system comprising:
a data path for carrying a data signal thereon, the data path coupled to receive a metering tone to be applied to the data signal; and
an interface in communication with the data path, the interface adapted to combine the data signal and metering tone with a voice signal for transmission over a transmission line.

2. The system of claim 1, wherein the interface is a hybrid, the hybrid adapted to divide the data path into a transmit portion and a receive portion.

3. The system of claim 1, wherein a transmit portion of the data path is coupled to receive the metering tone.

4. The system of claim 1, wherein the interface is coupleable to a DSL splitterless technology.

5. The system of claim 1, wherein the voice signal is a POTS signal below DSL frequencies.

6. The system of claim 1, further comprising:
a digital metering tone generator coupled to the data path, the digital metering tone generator adapted to generate the digital metering tone in response to an instruction therefor.

7. The system of claim 6, wherein the data path includes:
a converter operatively coupled to the interface and adapted to convert the data signal and metering tone from digital into analog.

8. The system of claim 7, wherein the data path further includes:
a high-pass filter coupled to receive the analog data signal from the converter,
wherein the magnitude of the metering tone in the data signal is maintained above a required level after the data signal is filtered by the high-pass filter.

9. The system of claim 6, further comprising:
a first converter operatively coupled to the interface and adapted to convert the data signal from digital into analog; and
a second converter operatively coupled to the interface and adapted to convert the digital metering tone from digital into analog.

10. The system of claim 1, further comprising:
an analog metering tone generator adapted to generate an analog metering tone, the analog metering tone generator operatively coupled to the interface for applying the analog metering tone to the data signal.

11. The system of claim 10, wherein the analog metering tone is generated in response to an instruction.

12. The system of claim 10, further comprising:
a low-pass filter coupled between the analog metering tone generator and the interface, the low-pass filter for attenuating frequencies of the generated metering tone within a data band.

13. A system for applying a metering tone to a DSL transmission, the system comprising:
a data processor for processing a digital data signal;
a converter operatively coupled to the data processor, the converter for converting the digital data signal into a corresponding analog data signal, the analog data signal for transmission in combination with a voice signal over a transmission line; and
application means for applying a metering tone to the digital data signal or the analog data signal before that data signal is combined with the voice signal.

14. The system of claim 13, wherein the application means comprises:
a digital metering tone generator adapted to generate the digital metering tone, the digital metering tone generator operatively coupled to an input of the converter, wherein the converter outputs an analog signal representing a combination of the data signal and the metering tone.

15. The system of claim 14, wherein the metering tone generator is adapted to generate a metering tone in response to a metering tone instruction.

16. The system of claim 13, wherein the application means comprises:
a digital metering tone generator adapted to generate a digital metering tone; and
a second converter having an input operatively coupled to the digital metering tone generator for receiving the digital metering tone, the second converter adapted to convert the digital metering tone into an analog metering tone.

17. The system of claim 13, wherein the application means comprises:
an analog metering tone generator adapted to generate an analog metering tone, the analog metering tone generator operatively coupled to an output of the converter, thereby for applying the analog metering tone to the analog data signal.

18. The system of claim 13, wherein the application means comprises:
a receiving means for receiving an analog metering tone, the receiving means operatively coupled to an output of the converter, thereby applying the analog metering tone to the analog data signal.

19. A method for applying a metering tone to a DSL transmission, the method comprising:
processing a data signal, the data signal for being transmitted in combination with a voice signal over a transmission line;
applying a metering tone to the data signal before the data signal is combined with the voice signal.

20. The method of claim 19, further comprising:
after applying the metering tone to the data signal, combining the data signal and the voice signal to form a DSL transmission signal.

21. The method of claim 19, wherein the voice signal is a POTS signal below DSL frequencies.

22. The method of claim 19, further comprising:
generating the metering tone that is applied to the data signal.

23. The method of claim 19, wherein generating the metering tone is responsive to an instruction to generate a metering tone.

24. The method of claim 22, further comprising:
amplifying the metering tone before applying the metering tone to the data signal.

25. The method of claim 22, further comprising:
high-pass filtering the data signal after the metering tone is applied thereto, wherein a magnitude of the metering tone in the DSL transmission is maintained at or above a required level.

26. The method of claim 22, further comprising:
converting the data signal and metering tone from digital to analog after applying the metering tone to the data signal.

27. The method of claim 19, further comprising:
combining the analog data signal and metering tone to a voice signal for transmission over the transmission line.

28. The method of claim 19, further comprising:
converting the data signal from digital to analog; and
separately converting the metering tone from digital to analog,
wherein applying the metering tone to the data signal includes coupling the analog metering tone to the analog data signal.

29. The method of claim 19, further comprising:
low-pass filtering the metering tone before applying the metering tone to the data signal, thereby attenuating at least some non-DSL band frequencies.

30. The method of claim 19, further comprising:
receiving the metering tone.

31. The method of claim 30, the method further comprising:
converting the data signal from digital to analog,
wherein the received metering tone is analog, and further wherein applying the metering tone to the data signal includes coupling the received analog metering tone to the converted analog data signal.
